(19) United States
(12) Patent Application Publication
(10) Pub. No.: US 2003/0127938 A1
(43) Pub. Date: Jul. 10, 2003

(54) Rotating electrical machine and method of manufacturing a rotating electrical machine

(76) Inventors: Jinxing Shen, Heidelberg (DE); Tom Porteous, Lutterworth (GB)

Correspondence Address: LERNER AND GREENBERG, P.A., POST OFFICE BOX 2480, HOLLYWOOD, FL, 33022-2480, US

(21) Appl. No.: 10/357,041

(22) Filed: Feb. 3, 2003

Related U.S. Application Data
(63) Continuation of application No. PCT/EP01/07671, filed on Jul. 5, 2001.

(30) Foreign Application Priority Data
Aug. 1, 2000 (DE) 100 37 410.7

(51) Int. Cl. H02K 1/00

(52) U.S. Cl. 310/216

(57) ABSTRACT

A rotating electrical machine has an inner rotor and an outer stator. Each of the two is wound from a strip. Each strip is subdivided into segments, which are matched to the inner and outer radius of curvature of the rotor or the stator. Each segment is provided with a defined number of slots which are arranged exactly one behind the other when winding the rotor or the stator so that, by this means, cavities are created for accommodating electrical windings.

### CROSS-REFERENCE TO RELATED APPLICATION

This application is a continuation of copending International Application No. PCT/EP01/07671, filed Jul. 5, 2001, which designated the United States and which was not published in English.

### BACKGROUND OF THE INVENTION

### FIELD OF THE INVENTION

The invention relates to a rotating electrical machine with a rotor and a stator, and to a method of manufacturing such a rotating electrical machine.

### SUMMARY OF THE INVENTION

It is accordingly an object of the invention to provide a rotating electrical machine and manufacturing method which overcomes the disadvantages of the heretofore-known devices and methods of this general type and which provides for a rotating electrical machine with a compact construction and an efficient method by way of which such a rotating electrical machine can be manufactured.

With the foregoing and other objects in view there is provided, in accordance with the invention, a rotating electrical machine, comprising:

a stator formed in one piece and wound from one strip; and

a rotor disposed to rotate relative to the stator, the rotor being formed in one piece and wound from one strip.

In accordance with an added feature of the invention, the stator is formed of a stator strip and includes an annular yoke and a core configured as a unit, the stator is formed with slots on a side pointing inwardly for accommodating electrical windings, and each two sequential slots are equally spaced apart and are separated from one another by a web, and the web has a root connected to the annular yoke and partially bounding the slots outwardly.

In accordance with an additional feature of the invention, the stator strip is subdivided into a defined number of segments having an inner radius and an outer radius of curvature matched to an inner radius and an outer radius of curvature of the stator, each the segment has a defined number of slots and each two immediately adjacent segments are only connected to one another at an outer edge of a lateral boundary surfaces, and a split line between two the segments is guided centrally through a web or a slot and an end located at an inside of each split line is formed with a recess, and two adjacent slots are equally spaced apart.

In accordance with another feature of the invention, the rotor is wound from a rotor strip subdivided into a defined number of segments having an inner radius and an outer radius of curvature matched to an inner radius and an outer radius of curvature of the rotor, each the segment is formed with a defined number of slots, each two immediately adjacent segments are only connected to one another at an outer edge of a lateral boundary surface, and a split line between two adjacent segments is guided centrally through a slot or centrally between two adjacent slots.

In accordance with a further feature of the invention, the slots are substantially closed on all sides and are separated from one another by webs, each two sequential slots are equally spaced from one another, and the slots have longitudinal axes inclined by an angle θs relative to a longitudinal axis of the slots of the stator, with reference to a total length of the stator.

In accordance with again another feature of the invention, the slots are formed with a small outwardly pointing opening and separated from one another by webs, each two sequential slots are equally spaced from one another, and the slots have longitudinal axes inclined by an angle θs relative to a longitudinal axis of the slots of the stator, with reference to a total length of the stator.

With the above and other objects in view there is also provided, in accordance with the invention, a method of manufacturing a rotating electrical machine, in particular the machine according to the above summary. The method comprises:

providing a stator strip formed with segments and a rotor strip formed with segments;

winding the stator strip in one piece to form a stator and winding the rotor strip in one piece to form a rotor.

In accordance with again an additional feature of the invention, the method includes the steps of providing the stator strip with a yoke and a core forming a unit wound from the stator strip, subdividing the stator strip into a defined number of segments with an inner radius and an outer radius of curvature matched to an inner radius and an outer radius of curvature of the stator, forming the segments with a defined number of inwardly open slots each separated from one another by a web, and, during the step of winding the stator, arranging a slot in each layer in congruence with and in front of a slot of a respectively previous layer, to form cavities of the stator.

In accordance with again another feature of the invention, the method comprises subdividing the rotor strip into a defined number of segments having an inner radius and an outer radius of curvature matched to an inner radius and an outer radius of curvature of the rotor, and providing each segment with a defined number of closed slots, with each two immediately adjacent segments connected to one another substantially only at an outer edge of lateral boundary surfaces thereof, and forming a split line between two adjacent segments leading through a slot or centrally between two adjacent slots.

In accordance with yet an added feature of the invention, during the winding of the rotor and the stator, split lines between the segments are offset relative to one another from one wound layer of the strip to a next wound layer, if the following equation is satisfied:

$$\frac{N + Na}{Nseg} = Zseg$$

where Zseg is a number of slots per segment, N is a total number of slots of a wound layer, Nseg is a number of segments of a wound layer, Na is a number of the slots in a displacement between the first split line of a layer that has been wound first and a first split line of a subsequent layer and if the following conditions are satisfied

Zseg=integer;

1≦Na<Zseg;

$$C = \frac{NxNseg}{N + Na} ,$$

integer; and

Nseg−C<1.

In accordance with yet an additional feature of the invention, the winding step comprises forming a fully-wound rotor with a core twisted by an angle θs, relative to a total length of the rotor, for aligning webs separating slots of the rotor from one another, relative to webs separating slots of the stator from one another.

In accordance with yet another feature of the invention, a fully-wound rotor is formed with a core inclined by an angle in a direction of the longitudinal axis in order to align webs separating the slots of the rotor from one another, relative to webs separating slots of the stator from one another, for increasing each web by a small distance Or and for increasing an angle of inclination of each slot and each protrusion by Δθ, where θr′=θr+Δθ and Δθ=θs/M/Nr, where M is a number of layers of the strip of the wound rotor and Nr is a number of the slots of the rotor.

In accordance with again another feature of the invention, two stator strips for winding the stator are cut to a specified pattern out of an elongated strip of sheet material having a width of less than two stator strips or a strip that is twice the width.

In accordance with a concomitant feature of the invention, two rotor strips for winding the rotor are cut to a specified pattern from a sheet-metal strip that is at least twice the width.

With the method according to the invention, a rotating electrical machine, i.e., a dynamoelectric machine, can be manufactured using less electrical steel than was previously the case. In the The machine according to the invention, both the rotor and the stator are wound from one strip each and this is subdivided into segments which are provided with specially configured slots. The connection locations of the segments are minimized in such a way that the strip cannot be broken during the further manufacturing process. The inner and outer radii of curvature of each segment are matched to the inner and outer radii of curvature of stator or rotor.

Other features which are considered as characteristic for the invention are set forth in the appended claims.

Although the invention is illustrated and described herein as embodied in a rotating electrical machine and method of manufacturing it, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a vertical section through a rotating electrical The machine according to the invention;

FIG. 2 is a plan view of a portion of a strip with which the stator is wound;

FIG. 3 is a plan view of a portion of a further strip for winding the stator;

FIG. 4 is a plan view illustrating the manufacture of strips, such as are shown in FIG. 2, from a strip-shaped structural element;

FIG. 5 is an end view showing the winding of the stator;

FIG. 6 is a radial view of the outer boundary surface of the stator;

FIG. 7 is a plan view of a portion of a strip for winding the rotor;

FIG. 8 is a plan view of a portion of a further strip for winding the rotor;

FIG. 9 illustrates the manufacture of strips, such as are shown in FIG. 7, from a strip-shaped material;

FIG. 10 illustrates the winding of the rotor;

FIG. 11 is a radial view of the outer boundary surface of the rotor;

FIG. 12 is a perspective view showing the twisting of the rotor core to align the protrusions between the slots.

### DESCRIPTION OF THE PREFERRED EMBODIMENTS

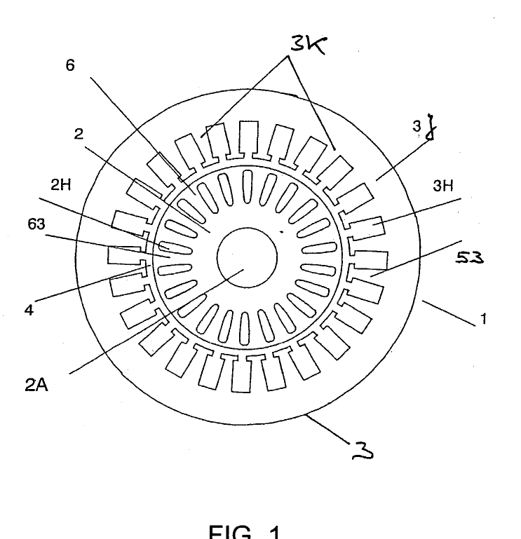

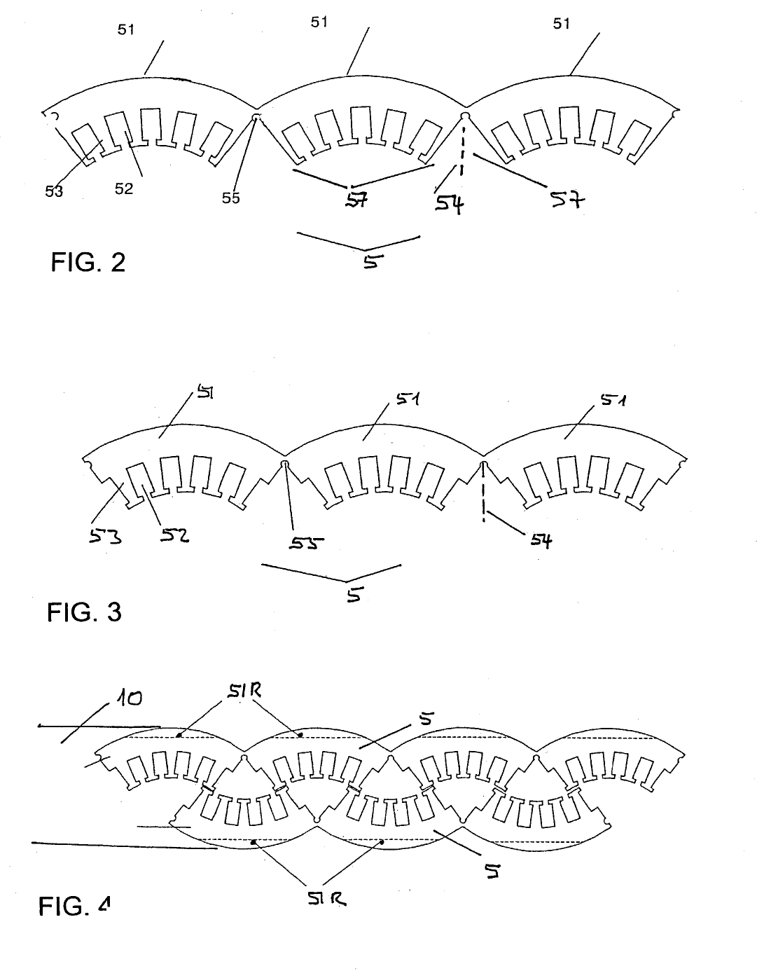

Referring now to the figures of the drawing in detail and first, particularly, to FIG. 1 thereof, there is shown a rotating electrical machine 1, i.e., a dynamoelectric machine, with a rotor 2 and a stator 3. As the vertical section shows, the rotor 2 is arranged within the stator 3. The dimensions of the rotor 2 are selected in such a way that a small air gap 4 remains between it and the stator 3. A non-illustrated shaft of the rotating electrical machine is aligned along the longitudinal axis of the rotor 2. The rotor 2 and the stator 3 are wound from specially shaped strips 5 and 6, as represented in FIGS. 2, 3, 6 and 7 and explained in the associated descriptions. A core 3K and a yoke 3J of the stator 3 form a unit. A strip 5, an example of which is represented as an excerpt in FIG. 2, is used for winding the stator 3. The strip 5 is subdivided into segments 51 whose inner and outer radius of curvature is matched to the inner and outer radius of curvature of the stator 3. The segments 51 are all the same size. Each two adjacent segments 51 are connected together, almost at points, right at the outside of their lateral boundary surfaces. Each segment 51 is provided with slots 52 all of which, in the embodiment example represented here, have an approximately rectangular cross section and are of the same size. The cross sections can also have a different shape. The invention is not limited exclusively to the embodiment represented here. It includes, in fact, all the shapes capable of functioning. The slots 52 are open towards the smaller radius of curvature of the segments 51. Each two adjacent slots 52 are stepped from one another by a T-shaped protrusion 53 such as is represented in FIGS. 1 to 5. Its root is connected to the closed region of the strip 5, which forms the yoke 3J of the stator 3. Each two adjacent slots 52 are partially closed towards the outside by the crosspiece of a protrusion 53, which crosspiece is aligned at right angles to the longitudinal axis of the slot 52. The dimensions and arrangement of the slots 52 and the dimensions of the segments 51 are selected in such a way that the split line 54 between two segments 51 is either led centrally through a slot 52, as represented in FIG. 3, or through a protrusion 53, as in the variant of a strip 5 represented in FIG. 2. The end, which is located within the strip 5, of a split line 54 opens into a round recess 55 which, during the winding of the stator 3, serves to concentrate and reduce the mechanical deformation.

FIG. 4 shows a strip-type structural element 10 in a thin sheet metallic material, which is configured as electrical sheet metal. The structural element 10 is as wide as two strips 5 laid opposite to one another, as shown in FIG. 3. Two such strips 5 of the pattern represented here are cut from this structural element 10. In order to save material, the structural element 10 can also be somewhat narrower than the pattern, for example in such a way that the curved parts 51R, directed towards the outside, of the segments 51 are omitted. On the outer surface, the wound stator 3 then is formed with partially flattened regions which do not, however, introduce any essential disadvantages. The reason for selecting this pattern is to minimize the amount of material.

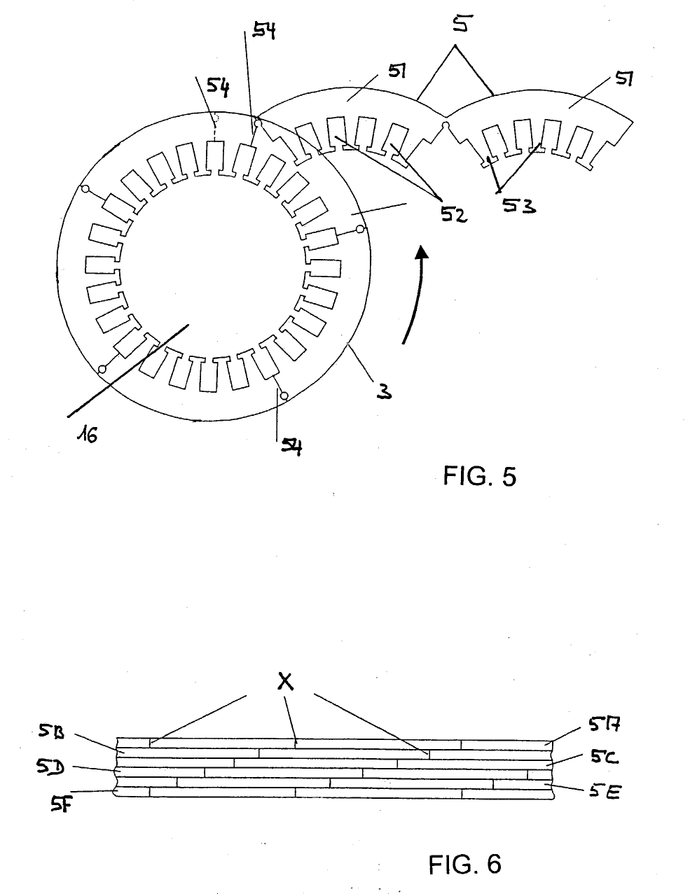

FIG. 5 shows the winding of the stator 3. For this purpose, the strip 5 is wound on a mandrel 16 in such a way that the strip segments 51 are positioned with their smaller radius of curvature at right angles to the longitudinal axis of the mandrel 16. The outer diameter of the mandrel 16 is matched to the desired inner diameter of the stator 3. The strip 5 is wound on until the stator 3 exhibits the desired dimensions. The strip 5 is then cut through. In order to prevent the strip 5 from unwinding freely from the mandrel 16, it is permanently fastened. The layers of the strip 5 which have been wound on are then pressed together. The stator 3 has then been completed. After the winding of the strip 5 and because of the uniform configuration of slots 52 and protrusions 53, a slot 52 of the previous layer and also, in each case, a slot 52 of the following layer of the strip 5 are congruently positioned before and after each slot 52 of each layer. By this means, through cavities 3H, as shown in FIG. 1, are configured in the stator 3; their longitudinal axes extend parallel to the longitudinal axis of the stator 3 and their cross sections correspond to the cross sections of the slots 52. The segments 51 are configured in such a way that the intermediate spaces 57, which have the shape of triangles and, as is shown in FIG. 2, are configured between each two segments 51, are closed to such an extent after the winding of the strip 5 that only a split line 54 still remains, as is shown in FIG. 5. FIG. 5 shows the split line 54 of a first wound layer, which is shown opened up, and a first split line 54 of a second wound layer. This is displaced sufficiently far from the split line 54 of the first layer for the distance between the two to correspond to the distance between the centers of two slots 52. FIG. 6 shows a partial region of the outer surface of the stator 3. The positions of the split lines 54 of six layers 5A, 5B, 5C, 5D, 5E, 5F of the strip 5 are marked by X. From this, it may be clearly seen that no split line (not shown here) is positioned immediately before or after another split line. In order to achieve this, the following relationship must be satisfied:

$$\frac{N + Na}{Nseg} = Zseg$$

and

Zseg=integer

1≦Na<Zseg

$$C + \frac{NxNseg}{N + Na} ,$$

integer

Nseg−C<1

Zseg is the number of slots 52 per segment, N is the number of all the slots 52 of a layer of the wound strip 5, Na is the number of slots 52 between the first split line 54 of a wound-on layer and the split line 54 of a following layer, which is determined by the displacement, Nseg is the whole number of segments necessary for winding on a layer and C is the precise number of segments in a layer. If, for example, a stator 3 has to be wound which has 24 slots and 5 segments per layer, then N=24, Nseg=5 and Na=1. It follows that Zseg=5 and C=4.8.

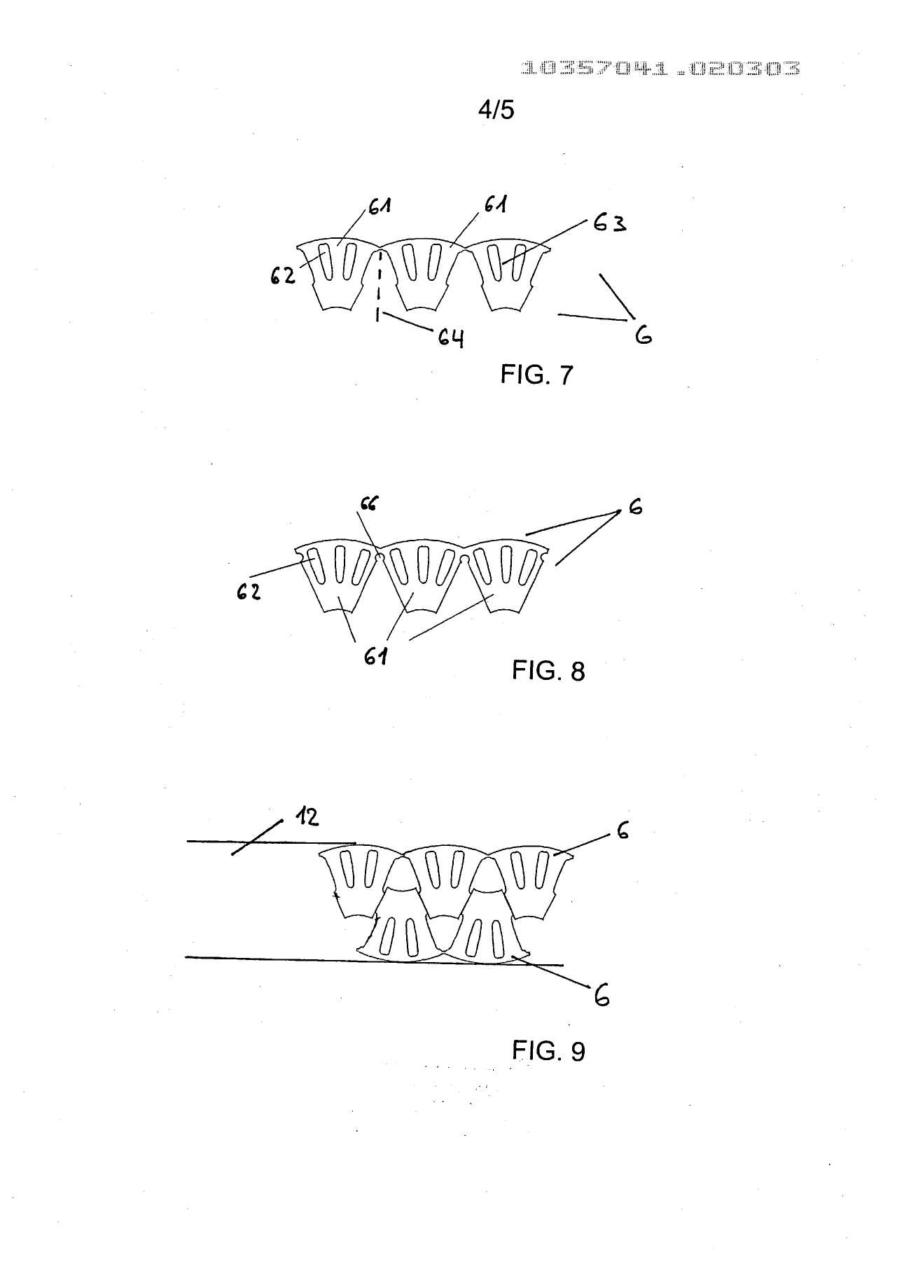

FIGS. 7 and 8 show the partial region, of a strip 6, which is used for winding the rotor 2. The strip 6 is subdivided into segments 61. Each segment 61 is matched to the inner and the outer radius of curvature of the rotor 2. The segments 61 are all the same size. As is represented in FIGS. 7 and 8, each segment 61 is provided with two or three slots 62, depending on whether the split line is guided centrally between two slots 62 or through a slot 62. In the embodiment example represented here, the slots 62 have an oval configuration, are all the same size, are closed towards the outside and are separated from one another by protrusions 63. If the segments 61 are configured in such a way that the split line is guided centrally through between two segments 61 then, as is represented in FIG. 8, the end of the split lines 64 located at the inside opens into a circular recess 66, which is used to reduce the mechanical deformation when winding the rotor 2.

FIG. 9 shows a structural element 12 in a thin metallic sheet material, which is configured as electrical sheet metal. In the exemplary embodiment represented here, the structural element 12 is twice as wide as two strips 6 of FIG. 7, which are here located opposite to one another. Corresponding to the pattern rep resented here, two strips 6 for winding the rotor 2 can be cut simultaneously from the structural element 12. Just as in the case of the pattern represented in FIG. 4, the reason for the selection of this pattern is to minimize the amount of material.

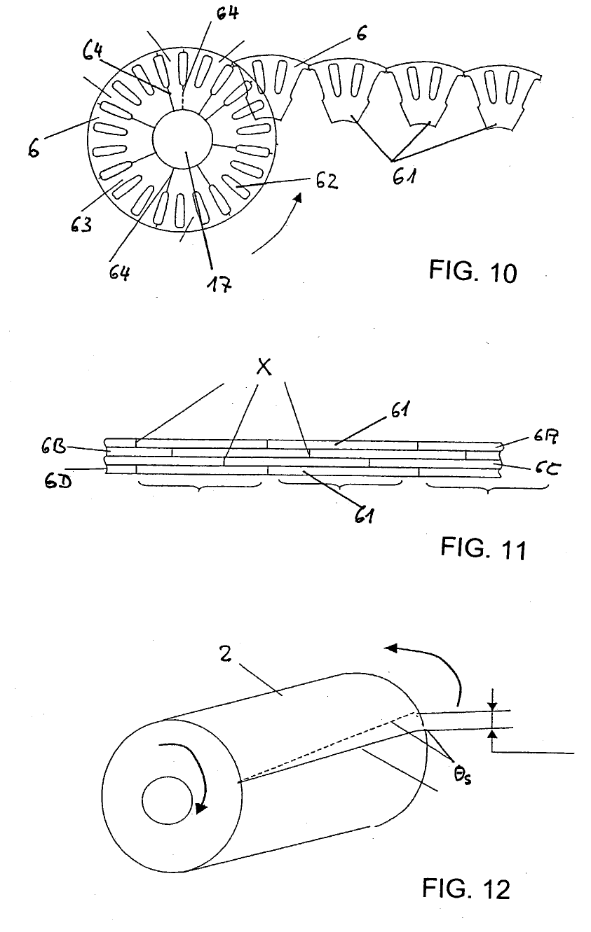

FIG. 10 shows the winding of the rotor 2. For this purpose, the strip 6 is wound on a mandrel 17 in such a way that the segment 61 is positioned with its smaller radius of curvature at right angles to the longitudinal axis of the mandrel 17. The outer diameter of the mandrel 17 is matched to the desired inner diameter of the rotor 2. The strip 6 is wound on until the rotor exhibits the desired dimensions. The strip 6 is then cut through. In order to prevent the strip 6 from unwinding freely from the mandrel 17, it is permanently fastened. The wound-on layers of the strip 6 are then pressed together.

Because of the uniformly configured slots 62 and protrusions 63, a slot 62 of the previous layer and also a slot 62 of the following layer of the strip 6 are positioned so that they are congruently positioned before and behind each slot 62 of a layer during the winding of the strip 6. By this means, through cavities 2H, as represented in FIG. 1, are configured in the rotor 2; their longitudinal axes extend parallel to the longitudinal axis of the rotor 2 and their cross sections correspond to the cross sections of the slots 62. In addition, the strip 6 is configured in such a way that no split line 64 is arranged, during the winding, before and after each split line 64 between two segments 51. FIG. 10 shows the split line 64 of a layer which has been wound first, and which is shown as an interrupted line, and a first split line 64 of a layer which has been wound on second. The split line 64 of the second layer is displaced sufficiently far from the split line 64 of the first layer for the distance between the two to correspond to the distance between the centers of two slots 62.

FIG. 11 shows a partial region of the outer surface of the rotor 2. The positions of the split lines 64 in four layers 6A, 6B, 6C, 6D of the strip 6 are marked by X. Here again, it may be seen that no split line (not shown here) is positioned directly before or after another split line. In order to achieve this, the above-mentioned equation

$$\frac{N + Na}{Nseg} = Zseg$$

must

be satisfied in this case too. The conditions which relate to the number of slots 62 and the number of segments 61 are the same as those explained in the description of FIG. 5.

During the manufacture of the rotor 2, it is also necessary to ensure that the longitudinal axes of the protrusion 63, by means of which the slots 62 are separated from one another, are inclined at an angle θs relative to the longitudinal axes of the protrusions 53, by means of which the slots 52 of the stator 3 are separated from one another. For this reason, the core of the rotor 2 is twisted, as represented in FIG. 12, relative to the longitudinal axis of the rotor 2 by this angle θs after the complete winding of the strip 6 and, in fact, in the same direction as that in which the strip 6 has also been rotated during winding. In order to achieve this inclination, the inner and outer curvatures of the segments 61 must be slightly modified. The precise cylindrical outer profile of the rotor 2 is only achieved by an appropriate final machining of the outer surface of the rotor 2.

The desired inclination of the longitudinal axes of the protrusion 63 can also be achieved by slightly increasing each protrusion 63 and, in fact, by θr. The angle θr=360°/Nr and Nr is the number of slots 62 in the rotor 2. The angle of inclination of each slot 62 and of each protrusion 63 has to be increased by Δθ, where θr′=θr+Δθ and Δθ=θs/M/Nr. The variable M is the number of layers of the wound-on strip 6 of the rotor 2 and θs is the angle about which the rotor 2 has to be twisted over its total length.

We claim:

1. A rotating electrical machine, comprising:
a stator formed in one piece and wound from one strip; and
a rotor disposed to rotate relative to said stator, said rotor being formed in one piece and wound from one strip.

2. The machine according to claim 1, wherein said stator is formed of a stator strip and includes an annular yoke and a core configured as a unit, said stator is formed with slots on a side pointing inwardly for accommodating electrical windings, and each two sequential slots are equally spaced apart and are separated from one another by a web, and said web has a root connected to said annular yoke and partially bounding said slots outwardly.

3. The machine according to claim 2, wherein said stator strip is subdivided into a defined number of segments having an inner radius and an outer radius of curvature matched to an inner radius and an outer radius of curvature of said stator, each said segment has a defined number of slots and each two immediately adjacent segments are only connected to one another at an outer edge of a lateral boundary surfaces, and a split line between two said segments is guided centrally through a web or a slot and an end located at an inside of each split line is formed with a recess, and two adjacent slots are equally spaced apart.

4. The machine according to claim 1, wherein said rotor is wound from a rotor strip subdivided into a defined number of segments having an inner radius and an outer radius of curvature matched to an inner radius and an outer radius of curvature of said rotor, each said segment is formed with a defined number of slots, each two immediately adjacent segments are only connected to one another at an outer edge of a lateral boundary surface, and a split line between two adjacent segments is guided centrally through a slot or centrally between two adjacent slots.

5. The machine according to claim 4, wherein said slots are substantially closed on all sides and are separated from one another by webs, each two sequential slots are equally spaced from one another, and said slots have longitudinal axes inclined by an angle θs relative to a longitudinal axis of said slots of said stator, with reference to a total length of said stator.

6. The machine according to claim 4, wherein said slots are formed with a small outwardly pointing opening and separated from one another by webs, each two sequential slots are equally spaced from one another, and said slots have longitudinal axes inclined by an angle θs relative to a longitudinal axis of said slots of said stator, with reference to a total length of said stator.

7. A method of manufacturing a rotating electrical machine, which comprises:
providing a stator strip formed with segments and a rotor strip formed with segments;
winding the stator strip in one piece to form a stator and winding the rotor strip in one piece to form a rotor.

8. The method according to claim 7, which comprises assembling the stator and the rotor to form the rotating electrical machine according to claim 1.

9. The method according to claim 7, which comprises providing the stator strip with a yoke and a core forming a unit wound from said stator strip, subdividing said stator strip into a defined number of segments with an inner radius and an outer radius of curvature matched to an inner radius and an outer radius of curvature of the stator, forming the segments with a defined number of inwardly open slots each separated from one another by a web, and, during the step of winding the stator, arranging a slot in each layer in congruence with and in front of a slot of a respectively previous layer, to form cavities of the stator.

10. The method according to claim 7, which comprises winding the rotor from the rotor strip, subdividing the rotor strip into a defined number of segments having an inner radius and an outer radius of curvature matched to an inner radius and an outer radius of curvature of the rotor, and providing each segment with a defined number of closed slots, with each two immediately adjacent segments connected to one another substantially only at an outer edge of lateral boundary surfaces thereof, and forming a split line between two adjacent segments leading through a slot or centrally between two adjacent slots.

11. The method according to claim 7, which comprises, during the winding of the rotor and the stator, offsetting split lines between the segments relative to one another from one wound layer of the strip to a next wound layer, if the following equation is satisfied:
$$\frac{N + Na}{Nseg} = Zseg$$
where Zseg is a number of slots per segment, N is a total number of slots of a wound layer, Nseg is a number of segments of a wound layer, Na is a number of the slots in a displacement between the first split line of a layer that has been wound first and a first split line of a subsequent layer and if the following conditions are satisfied
Zseg =integer;
1≦Na<Zseg;
$$C = \frac{NxNseg}{N + Na} ,$$
integer; and
Nseg−C<1.

12. The method according to claim 7, wherein the winding step comprises forming a fully-wound rotor with a core twisted by an angle θs, relative to a total length of the rotor, for aligning webs separating slots of the rotor from one another, relative to webs separating slots of the stator from one another.

13. The method according to claim 7, which comprises forming a fully-wound rotor with a core inclined by an angle in a direction of the longitudinal axis in order to align webs separating the slots of the rotor from one another, relative to webs separating slots of the stator from one another, for increasing each web by a small distance Or and for increasing an angle of inclination of each slot and each protrusion by Δθ, where θr′=θr+Δθ and Δθ=θs/M/Nr, where M is a number of layers of the strip of the wound rotor and Nr is a number of the slots of the rotor.

14. The method according to claim 7, which comprises providing an elongated strip of sheet material having a width of less than two stator strips and cutting two stator strips for winding the stator to a specified pattern out of the elongated strip.

15. The method according to claim 7, which comprises providing an elongated strip of sheet material having a width accommodating at least two stator strips and cutting two stator strips for winding the stator to a specified pattern out of the elongated strip.

16. The method according to claim 7, which comprises providing an elongated strip of sheet material having a width accommodating at least two rotor strips, and cutting two rotor strips for winding the rotor to a specified pattern from the strip.
